(19) United States
(12) Patent Application Publication
(10) Pub. No.: US 2017/0310629 A1
(43) Pub. Date: Oct. 26, 2017

(54) Providing Reverse Preference Designations In a Network

(71) Applicant: Google Inc., Mountain View, CA (US)

(72) Inventors: Jia Liu, Sunnyvale, CA (US); Dongmin Zhang, Sunnyvale, CA (US); Xincheng Zhang, Sunnyvale, CA (US)

(21) Appl. No.: 13/663,996

(22) Filed: Oct. 30, 2012

(51) Int. Cl. H04L 12/58

(52) U.S. Cl. CPC H04L 51/32

(57) ABSTRACT

This technology is directed to systems and methods for indicating preference settings in a network, for example, a social network, that prevent other users with whom a particular user shares affinity from transmitting communications and/or social content relating to the particular user to those who are not within the particular user's social groups. The systems and methods provide user preferences that specify user designations relating to content or communication indicated by others that involve the users.

### BACKGROUND

The present disclosure relates to technology configured to facilitate reversed privacy settings in a network.

Over the last decade or so, communications via online communities, for example, a social network or the like, are becoming increasingly popular. Users of social networks communicate with those with whom they share an affinity, by sharing comments, observations, pictures etc. In current social networks, a user can indicate user preferences and restrictions on who can view user posts. Yet, there is no way for a particular user of a social network to specify or control posts by other users of the social network that reference or involve the particular user. For example, take a scenario where user may be in a photograph that a friend provides to others in his or her social group and someone in that group tags it, communicating it to yet others. As another example scenario, a user's friend may communicate to others a list of invitees or attendees to a party, which the user may wish to keep private.

### SUMMARY

In one innovative aspect, the present disclosure of the technology includes a system including a processor and memory including instructions that, when executed, cause the system to: receive social content from a particular user within a network; determine at least one user identified in the social content; evaluate an indication by the particular user to provide the social content to other users in the network; determine user restrictions designated by the identified user to indicate user preferences and consider the user preferences in relation to the social content before providing the social content to other users in the network further to the indication by the particular user; and execute visibility of the social content based on the user restrictions designated by the identified user for the social content.

In general, another innovative aspect of the present disclosure includes a method, using at least one computing device, for receiving social content from a particular user within a network; determining at least one user identified in the social content; evaluating an indication by the particular user to provide the social content to other users in the network; determining user restrictions designated by the identified user to indicate user preferences and considering the user preferences in relation to the social content before providing the social content to other users in the network further to the indication by the particular user; and executing visibility of the social content based on the user restrictions designated by the identified user for the social content.

Other implementations of one or more of these aspects include corresponding systems, apparatus, and computer programs, configured to perform the action of the methods, encoded on computer storage devices. These and other implementations may each optionally include one or more of the following features.

For instance, the operations further include: restricting viewing of the social content by others within the network and outside the network according to preferences, wherein the social content may be a post, a comment on the post, a friend list, or an invitation list.

For instance, the features include: user restrictions for restricting viewing of social content by others within the network and outside the network, wherein the social content may be a post, a comment on the post, a friend list, or an invitation list.

The systems and methods disclosed below are advantageous in a number of respects. With the ongoing trends and growth in social networks, it may be beneficial for a network, for example, a social network, to factor in preferences of people who are involved in social content (for example, photographs etc.) provided by users of a social network. The systems and methods described here better protects user privacy by protecting, not only the social content created or transmitted by the user to others, but the privacy of those who appear in the social content that is freely transmitted without consent of those who appear in the social content.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a block diagram illustrating an example system for determining and controlling content visibility including a content-visibility-determination and control application.

FIG. 2 is a block diagram illustrating example hardware components in some implementations of the example system shown in FIG. 1.

FIG. 3 is a block diagram illustrating an example content-visibility-determination and control application and its software components.

FIG. 4 is a flow chart of an example method for controlling the visibility of a photograph.

FIG. 5 is a flow chart of an example method for controlling the visibility of user-related content in a friend list.

FIG. 6 is a flow chart of an example method for controlling the visibility of user-related content in an invitation list.

FIG. 7 is a graphical representation of an example user interface including an example user's social stream.

FIG. 8 is a graphical representation of an example user interface for designating permission settings.

FIG. 9 is a graphical representation of an example user interface for blocking content based on the permission settings.

### DETAILED DESCRIPTION

In some implementations, this technology includes systems and methods configured to determine and control social content visibility based on the permission settings of the one or more users of a network. As one example, certain users may want to either limit or restrict display of their social content, for example, photographs or other visual content to others within the network and outside the network. Hence, those involved in particular social content (for example, those who appear in a photograph and are “tagged,” by which action the photograph would be sent to all those tagged) may specify in the network that they want to limit or restrict flow and display of photographs that include them. The systems and methods protect users' information (included in other users' posts) in several ways. For example, a first user posts a photograph including a second user. The first user “tags” the second user (along with others in the photograph) in the photograph and the first user shares the photograph with his/her friends. However, the second user may not want the friends of the first user (except common friends) to see him or her in the photograph or his or her name tagged on the photograph.

As another example, a first user initiates an event and invites a second user among others. The first user specifies who can view the invitation list. However, the second user may not want others to see his or her name and response to this invitation (revealing the second user's intentions and whereabouts).

As yet another example, a second user may be included in a first user's “friend” list. The first user may be inclined to freely make his or her profile public. Yet, the second user may not want others to know that the second user is in the first user's “friend” list.

As yet another example, a second user may be included in a first user's “friend” list. The first user may elect to make his or her profile public, may be active in social networks, and may frequently comment on the second user's posts. However, the second user may not want the public to see the first user's comments to the second user's posts. Therefore, the present technology is configured to permit users to specify their privacy preferences relating to social content that involves or includes them, which are considered and executed by the systems and methods in the flow of the social content within the network and outside the network if routed from within the network.

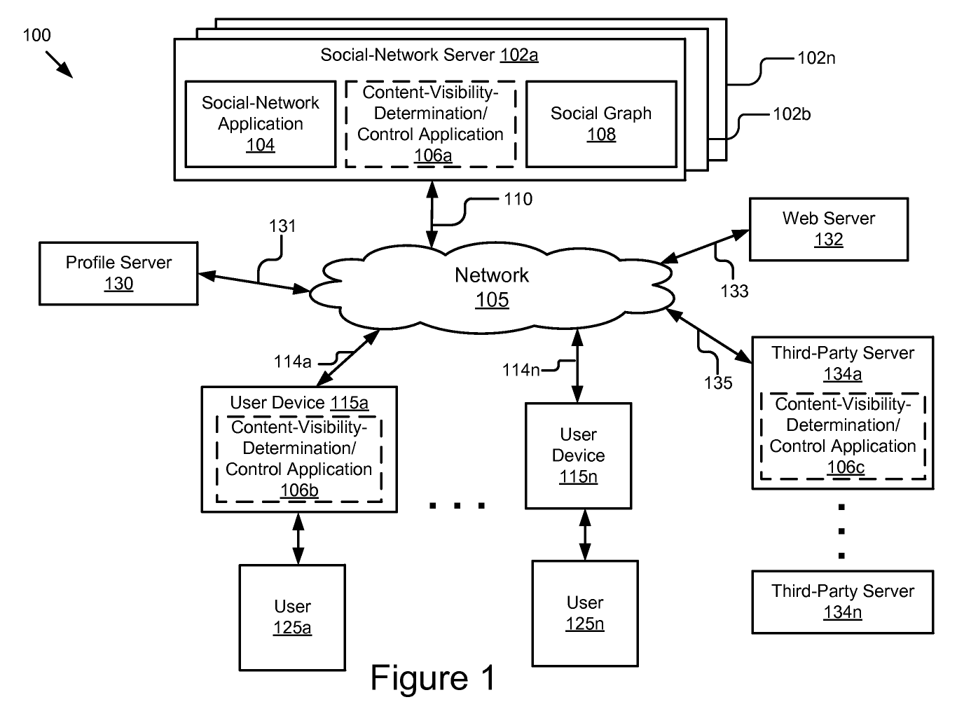

FIG. 1 is a high-level block diagram illustrating some implementations of systems for determining and controlling content visibility within an online community, for example, social networks. The system 100 illustrated in FIG. 1 provides system architecture (distributed or other) for determining and controlling content visibility based on the settings of users included in the content. The system 100 includes one or more social network servers 102a, 102b, through 102n, that may be accessed via user devices 115a through 115n, which are used by users 125a through 125n, to connect to one of the social network servers 102a, 102b, through 102n. These entities are communicatively coupled via a network 105. Although only two user devices 115a through 115n are illustrated, one or more user devices 115n may be used by one or more users 125n.

Moreover, while the present disclosure is described below primarily in the context of providing a framework for controlling visibility of social content, the present disclosure may be applicable to other situations. For ease of understanding and brevity, the present disclosure is described in reference to determining and controlling visibility of social content within a social network and in instances where the social content is forwarded or transmitted from within the network to others outside the network.

The user devices 115a through 115n in FIG. 1 are illustrated simply as one example. Although FIG. 1 illustrates only two devices, the present disclosure applies to a system architecture having one or more user devices 115, therefore, one or more user devices 115n may be used. Furthermore, while only one network 105 is illustrated as coupled to the user devices 115a through 115n, the social network servers, 102a-102n, the profile server 130, the web server 132, and third party servers 134a through 134n, in practice, one or more networks 105 may be connected to these entities. In addition, although only two third party servers 134a through 134n are shown, the system 100 may include one or more third party servers 134n.

In some implementations, the social network server 102a may be coupled to the network 105 via a signal line 110. The social network server 102a includes a social network application 104, which includes the software routines and instructions to operate the social network server 102a and its functions and operations. Although only one social network server 102a is described here, multiple servers may be present, as illustrated by social network servers 102b through 102n, each with functionality similar to the social network server 102a, or different.

In some implementations, the social network server 102a may be coupled to the network 105 via a signal line 110. The social network server 102a includes a social network application 104, which includes the software routines and instructions to operate the social network server 102a and its functions and operations. Although only one social network server 102a is described here, multiple servers may be present, as illustrated by social network servers 102b through 102n, each with functionality similar to social network server 102a or different.

The term “social network” as used here includes, but is not limited to, a type of social structure where the users are connected by a common feature or link. The common feature includes relationships/connections, e.g., friendship, family, work, a similar interest, etc. The common features are provided by one or more social networking systems, for example those included in the system 100, including explicitly-defined relationships and relationships implied by social connections with other online users, where the relationships form the social graph 108.

The term “social graph” as used here includes, but is not limited to, a set of online relationships between users, for example provided by one or more social networking systems, for example the social network system 100, including explicitly-defined relationships and relationships implied by social connections with other online users, where the relationships form a social graph 108. In some examples, the social graph 108 may reflect a mapping of these users and how they are related to one another.

The social network server 102a and the social network application 104 as illustrated are representative of a single social network. Each of the plurality of social network servers 102a, 102b through 102n, may be coupled to the network 105, each having its own server, application, and social graph. For example, a first social network hosted on a social network server 102a may be directed to business networking, a second on a social network server 102b directed to or centered on academics, a third on a social network server 102c (not separately shown) directed to local business, a fourth on a social network server 102d (not separately shown) directed to dating, and yet others on social network server (102n) directed to other general interests or perhaps a specific focus.

A profile server 130 is illustrated as a stand-alone server in FIG. 1. In other implementations of the system 100, all or part of the profile server 130 may be part of the social network server 102a. The profile server 130 may be connected to the network 105 via a line 131. The profile server 130 has profiles for the users that belong to a particular social network 102a-102n. One or more third party servers 134a through 134n are connected to the network 105, via signal line 135. A web server 132 may be connected, via line 133, to the network 105.

The social network server 102a includes a content-visibility-determination/control application 106a, to which user devices 115a through 115n are coupled via the network 105. In particular, user devices 115a through 115n may be coupled, via signal lines 114a through 114n, to the network 105. The user 125a interacts via the user device 115a to access the content-visibility-determination/control application 106 to either create, share, and/or view social content within a social network. The content-visibility-determination/control application 106 or certain components of it may be stored in a distributed architecture in one or more of the social network server 102, the third party server 134, and the user device 115. In some implementations, the content-visibility-determination/control application 106 may be included, either partially or entirely, in one or more of the social network server 102, the third party server 134, and the user device 115.

The user devices 115a through 115n may be a computing device, for example, a laptop computer, a desktop computer, a tablet computer, a mobile telephone, a personal digital assistant (PDA), a mobile email device, a portable game player, a portable music player, a television with one or more processors embedded in the television or coupled to it, or an electronic device capable of accessing a network.

The network 105 may be of conventional type, wired or wireless, and may have a number of configurations for example a star configuration, token ring configuration, or other configurations. Furthermore, the network 105 may comprise a local area network (LAN), a wide area network (WAN, e.g., the Internet), and/or another interconnected data path across which one or more devices may communicate.

In some implementations, the network 105 may be a peer-to-peer network. The network 105 may also be coupled to or include portions of one or more telecommunications networks for sending data in a variety of different communication protocols.

In some instances, the network 105 includes Bluetooth communication networks or a cellular communications network for sending and receiving data for example via short messaging service (SMS), multimedia messaging service (MMS), hypertext transfer protocol (HTTP), direct data connection, WAP, email, etc.

In some implementations, the social network servers, 102a-102n, the profile server 130, the web server 132, and the third party servers 134a through 134n are hardware servers including a processor, memory, and network communication capabilities. One or more of the users 125a through 125n access one or more of the social network servers 102a through 102n, via browsers in their user devices and via the web server 132.

As one example, in some implementations of the system, information of particular users (125a through 125n) of a social network 102a through 102n may be retrieved from the social graph 108. It should be noted that information that may be retrieved for particular users is only upon obtaining the necessary permissions from the users, in order to protect user privacy and sensitive information of the users.

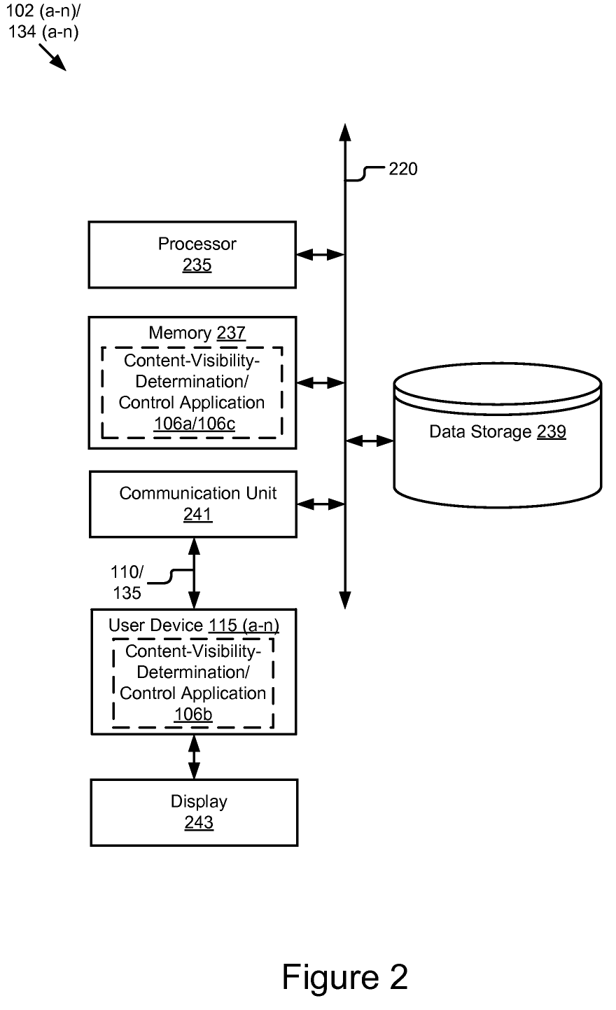

FIG. 2 is a block diagram illustrating some implementations of a social network server 102a through 102n and a third party server 134a through 134n, the system including a content-visibility-determination/control application 106a. In FIG. 2, like reference numerals have been used to reference like components with the same or similar functionality that has been described above with reference to FIG. 1. Since those components have been described above that description is not repeated here. The system generally includes one or more processors, although only one processor 235 is illustrated in FIG. 2. The processor may be coupled, via a bus 220, to memory 237 and data storage 239, which stores commentary information, received from the other sources identified above. In some instances, the data storage 239 may be a database organized by the social network. In some instances, the content-visibility-determination/control application 106 may be stored in the memory 237.

A user 125a, via a user device 115a, may either create, share, and/or view social content within a social network, via communication unit 241. In some implementations, the user device may be communicatively coupled to a display 243 to display information to the user. The content-visibility-determination/control application 106a and 106c may reside, in their entirety or parts of them, in the user's device (115a through 115n), in the social network server 102a (through 102n), or, in a separate server, for example, in the third party server 134 (FIG. 1). The user device 115a communicates with the social network server 102a using the communication unit 241, via signal line 110.

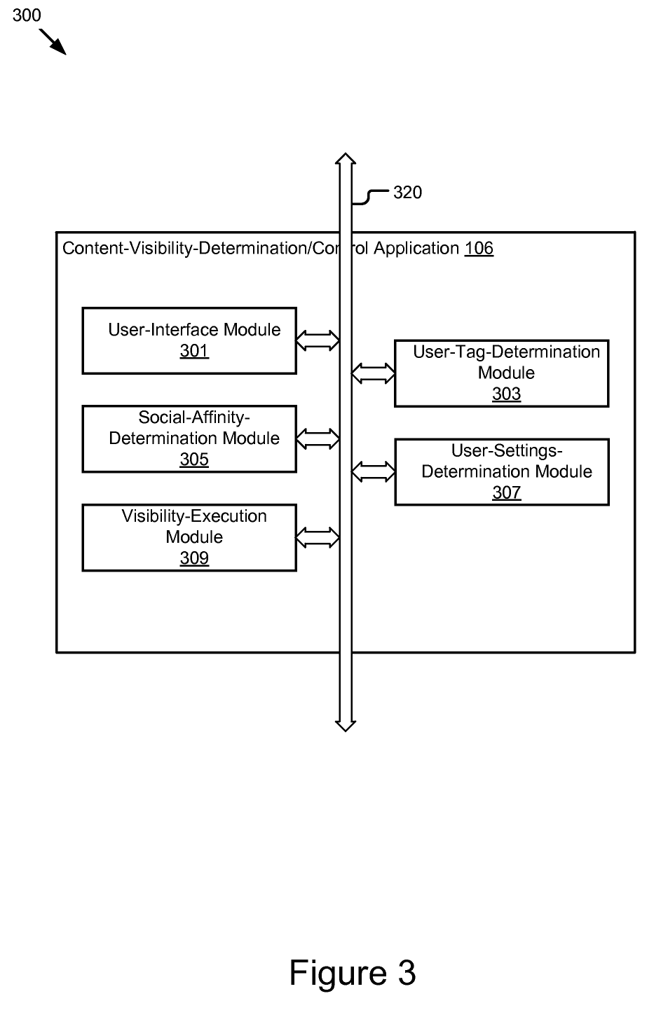

Referring now to FIG. 3, like reference numerals have been used to reference like components with the same or similar functionality that has been described above with reference to FIGS. 1 and 2. Since those components have been described above that description is not repeated here. An implementation of the content-visibility-determination/control application 106, indicated in FIG. 3 by reference numeral 300, includes various applications or engines that are programmed to perform the functionalities described here. A user-interface module 301 generates a user interface for displaying content within a social network. A user-tag-determination module 303 determines one or more users tagged/included in the social content. A social-affinity-determination module 305 determines the social affinity among the one or more users tagged/included in the social content and the user that posted the content. A user-settings-determination module 307 determines the user privacy setting designations within the user's social profile. A visibility-execution module 309 sets the visibility of the content based on the privacy settings of the one or more users tagged/included in the social content and the user that posted the content.

The content-visibility-determination/control application 106 includes applications or engines that communicate over the software communication mechanism 320. Software communication mechanism 320 may be an object bus (for example CORBA), direct socket communication (for example TCP/IP sockets) among software modules, remote procedure calls, UDP broadcasts and receipts, HTTP connections, function or procedure calls, etc. Further, the communication could be secure (SSH, HTTPS, etc.). The software communication may be implemented on underlying hardware, for example a network, the Internet, a bus 220 (FIG. 2), a combination thereof, etc.

The user-interface module 301 may be software including routines for generating a user interface. In some implementations, the user-interface module 301 can be a set of instructions executable by the processor 235 to provide the functionality described below for generating a user interface for displaying content within a social network. In other implementations, the user-interface module 301 can be stored in the memory 237 of the social network server 102 and/or the third party server 134 and can be accessible and executable by the processor 235. In either implementation, the user-interface module 301 can be adapted for cooperation and communication with the processor 235, the communication unit 241, data storage 239 and other components of the social network server 102 and/or the third party server 134 via the bus 220.

In some implementations, the user interface module 301 receives social content from one or more users of the social network. For example, the user interface module 301 receives one or more posts, comments, invitations, user profiles, etc., from one or more users of the social network.

In some implementations, the user interface module 301 generates a user interface for displaying information received from one or more modules described below. For example, the user interface module 301 generates one or more user interfaces for displaying user profile information, user content, and/or other information relating to the social network.

The user-tag-determination module 303 may be software including routines for determining users tagged in social content. In some implementations, the user-tag-determination module 303 can be a set of instructions executable by the processor 235 to provide the functionality described below for determining one or more users tagged/included in the social content. In other implementations, the user-tag-determination module 303 can be stored in the memory 237 of the social network server 102 and/or the third party server 134 and can be accessible and executable by the processor 235. In either implementation, the user-tag-determination module 303 can be adapted for cooperation and communication with the processor 235, the communication unit 241, data storage 239 and other components of the social network server 102 and/or the third party server 134 via the bus 220.

In some implementations, the user-tag-determination module 303 determines one or more users in social content (e.g., pictures, posts, videos, social lists, etc.). For example, the user-tag-determination module 303 determines one or more users and their corresponding profile in a photograph and/or video (e.g., by tags, face recognition, etc.). In some instances, the user-tag-determination module 303 identifies users in a post, friends list, invitation of an event, etc.

The social-affinity-determination module 305 may be software including routines for determining social affinities. In some implementations, the social-affinity-determination module 305 can be a set of instructions executable by the processor 235 to provide the functionality described below for determining the social affinity among the one or more users tagged/included in the social content and the user that posted the content. In other implementations, the social-affinity-determination module 305 can be stored in the memory 237 of the social network server 102 and/or the third party server 134 and can be accessible and executable by the processor 235. In either implementation, the social-affinity-determination module 305 can be adapted for cooperation and communication with the processor 235, the communication unit 241, data storage 239 and other components of the social network server 102 and/or the third party server 134 via the bus 220.

In some implementations, the social-affinity-determination module 305 determines the social affinity between one or more users of the social network. For example, the social-affinity-determination module 305 determines that some of the users obtained from the user-tag-determination module 303 (e.g., users in a tagged photograph) are friends with each other and others are not friends with each other.

The user-settings-determination module 307 may be software including routines for determining user settings. In some implementations, the user-settings-determination module 307 can be a set of instructions executable by the processor 235 to provide the functionality described below for determining the user privacy setting designations within the user's social profile. In other implementations, the user-settings-determination module 307 can be stored in the memory 237 of the social network server 102 and/or the third party server 134 and can be accessible and executable by the processor 235. In either implementation, the user-settings-determination module 307 can be adapted for cooperation and communication with the processor 235, the communication unit 241, data storage 239 and other components of the social network server 102 and/or the third party server 134 via the bus 220.

In some implementations, the user-settings-determination module 307 receives input (direct or indirect) from a user profile and sets the user settings for privacy (e.g., visibility of content that references the user). For example, a user indicates that he/she wants content (in which he or she is either referenced, involved, or included) to be private and the user-settings-determination module 307 sets the user's reverse privacy preference to “private.” In some instances the privacy may be indicated in a variable scale indicating different levels of privacy. This setting specifies how to protect a user's identity when the user's identity appears in other user's posts. For example, if a user is tagged in a photograph and the tagged user has designated a “reverse” privacy setting as “only my friends can see it,” then, only friends who are determined to be common with the user who posted the content may view it. In this instance, the common friends are those friends of the user that posted the content and the tagged user, in other words, friends who appear in both their friend lists, may view the tagged user's image or name in the content.

The visibility-execution module 309 may be software including routines for setting the visibility of social content. In some implementations, the visibility-execution module 309 can be a set of instructions executable by the processor 235 to provide the functionality described below for setting the visibility of the content based on the privacy settings of the one or more users tagged/included in the social content and the user that posted the content. In other implementations, the visibility-execution module 309 can be stored in the memory 237 of the social network server 102 and/or the third party server 134 and can be accessible and executable by the processor 235. In either implementation, the visibility-execution module 309 can be adapted for cooperation and communication with the processor 235, the communication unit 241, data storage 239 and other components of the social network server 102 and/or the third party server 134 via the bus 220.

In some implementations, the visibility-execution module 309 sets the visibility of the social content based on the social affinity information (from the social-affinity-determination module 305) and/or the user's preference (from the user-settings-determination module 307). For example, the visibility-execution module 309 determines that a tagged user's preference is set to private and sets the visibility to “not visible” if the user attempting to view the content does not share a social affinity with the tagged user (e.g., not friends).

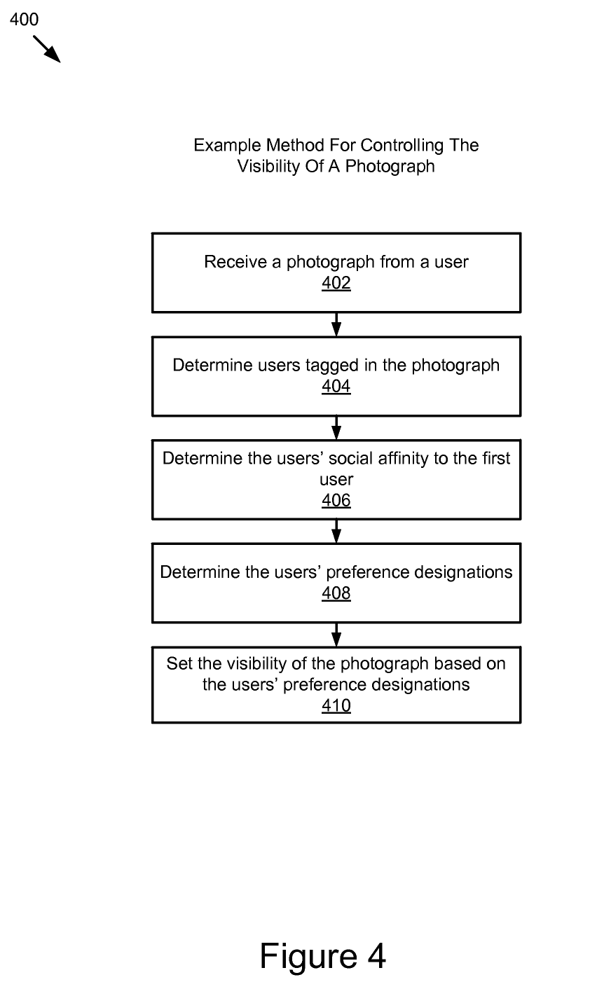

FIG. 4 is an example method indicated by reference numeral 400 for controlling the visibility of a photograph within a social network. It should be understood that the order of the operations in FIG. 4 is merely by way of example and may be performed in different orders than those that are illustrated and some operations may be excluded, and different combinations of the operations may be performed. In the example method 400 illustrated, one or more operations may include receiving a photograph from a user, as illustrated by block 402. The method 400 then proceeds to the next block 404 and may include one or more operations to determine users tagged in the photograph. The method 400 then proceeds to the next block 406 and may include one or more operations to determine the users' social affinity to the first user. The method 400 then proceeds to the next block 408 and may include one or more operations to determine the users' preference designations. The method 400 then proceeds to the next block 410 and may include one or more operations to set the visibility of the photograph based on the users' preference designations.

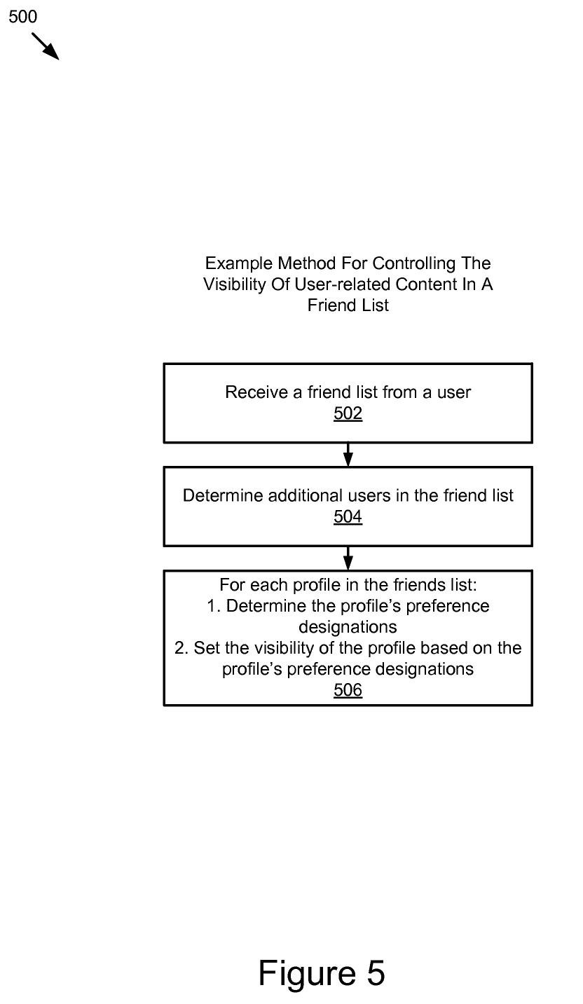

FIG. 5 is an example method indicated by reference numeral 500 for controlling the visibility of user-related content in a friend list within a social network. It should be understood that the order of the operations in FIG. 5 is merely by way of example and may be performed in different orders than those that are illustrated and some operations may be excluded, and different combinations of the operations may be performed. In the example method 500 illustrated, one or more operations may include receiving a friend list from a user, as illustrated by block 502. The method 500 then proceeds to the next block 504 and may include one or more operations to determine additional users in the friend list. The method 500 then proceeds to the next block 506 and may include one or more operations to, for each profile in the friends list, that: 1.) determine the profile's preference designations and 2.) set the visibility of the profile based on the profile's preference designations.

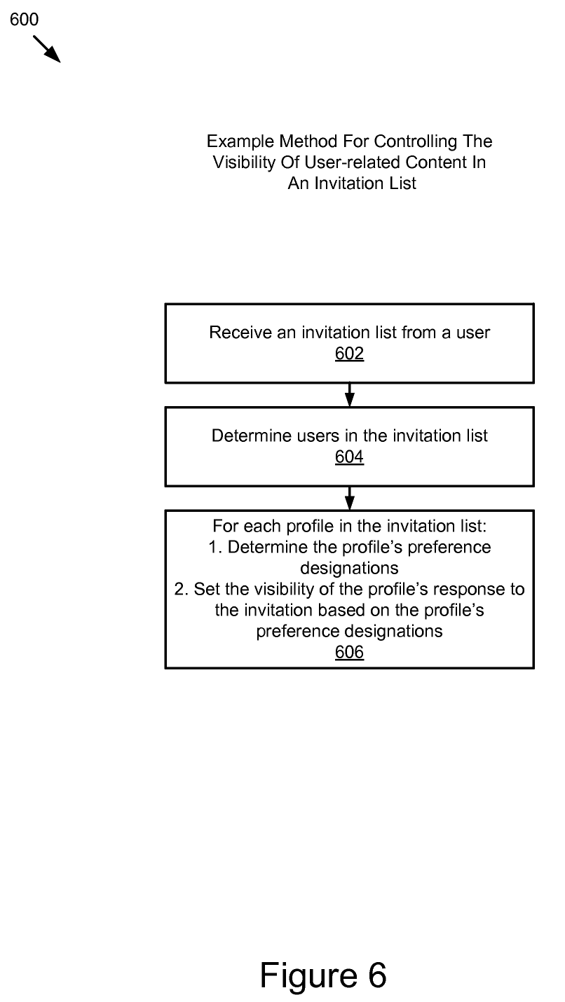

FIG. 6 is an example method indicated by reference numeral 600 for controlling the visibility of user-related content in an invitation list within a social network. It should be understood that the order of the operations in FIG. 6 is merely by way of example and may be performed in different orders than those that are illustrated and some operations may be excluded, and different combinations of the operations may be performed. In the example method 600 illustrated, one or more operations may include receiving an invitation list from a user, as illustrated by block 602. The method 600 then proceeds to the next block 604 and may include one or more operations to determine users in the invitation list. The method 600 then proceeds to the next block 606 and may include one or more operations to, for each profile in the invitation list: 1.) determine the profile's preference designations and 2.) set the visibility of the profile's response to the invitation based on the profile's preference designations.

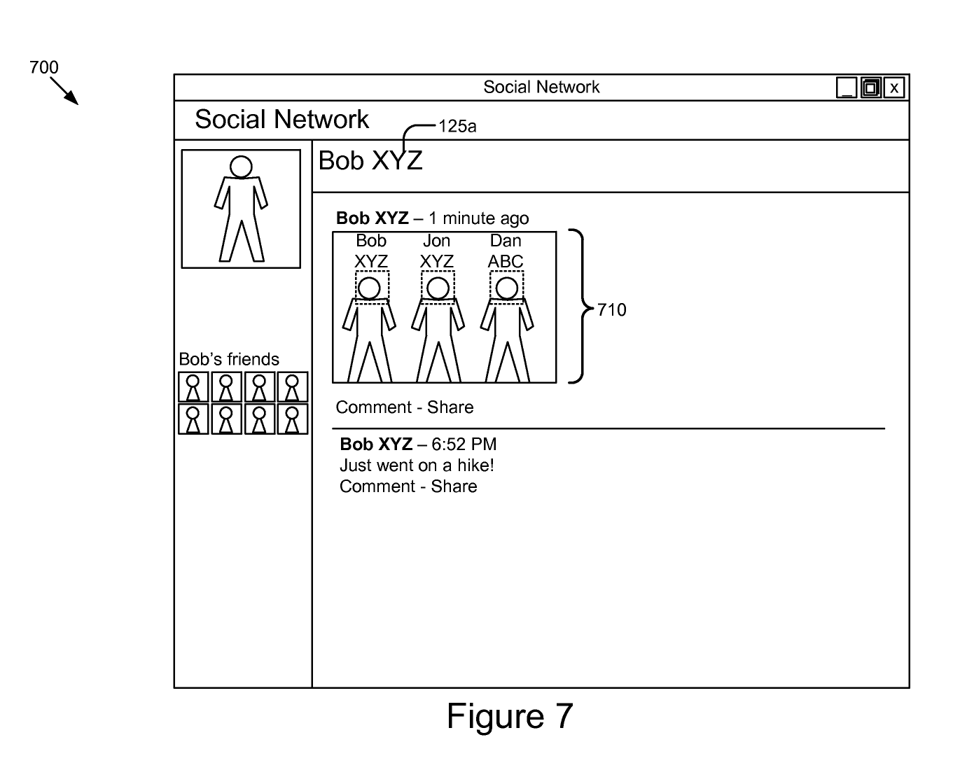

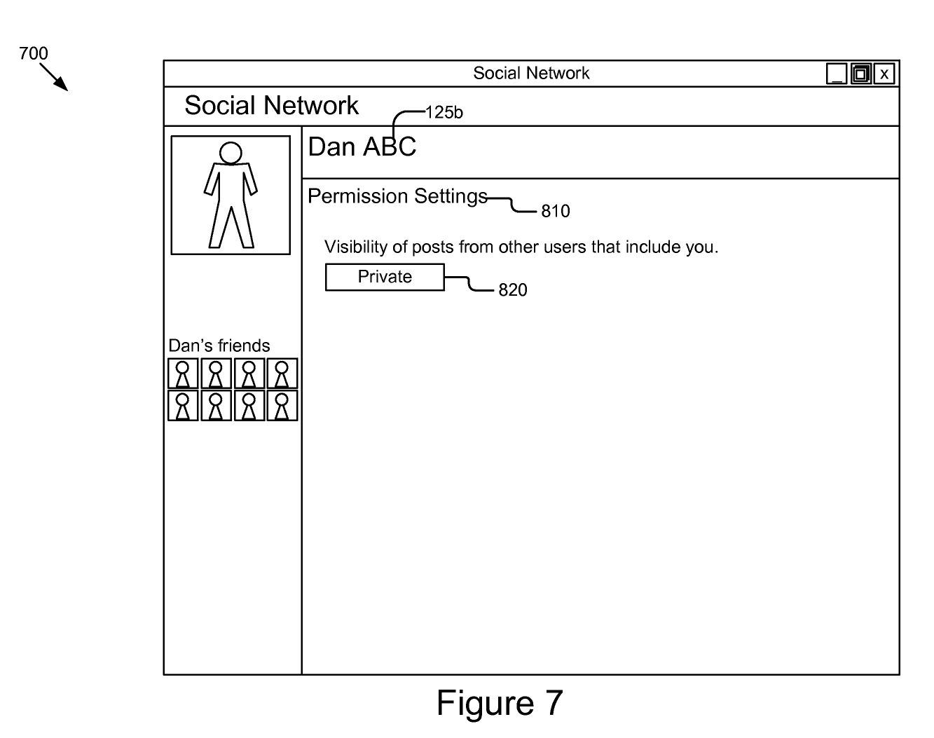

FIG. 7 is a graphical representation of an example user interface (indicated by reference numeral 700) illustrating a scenario where a user posts a photograph on a social network and tags three users in the photograph. In this instance, the action is tagging of users within visual content, for example, a photograph provided by a particular user Bob XYZ (user 125a) and including users Jon XYZ and Dan ABC (user 125b). In this example of the user interface 700, a browser window is illustrated including a social network application. In this example, the user 125a has tagged Jon XYZ and Dan ABC in a photograph included in the social stream post 710, therefore, the system receives the privacy settings for one or more users in the photograph. Likewise, the user interface 700 may include other routine indications, for example, a post indicating that Bob XYZ (user 125a) went on a hike, with indications to either comment or share the post.

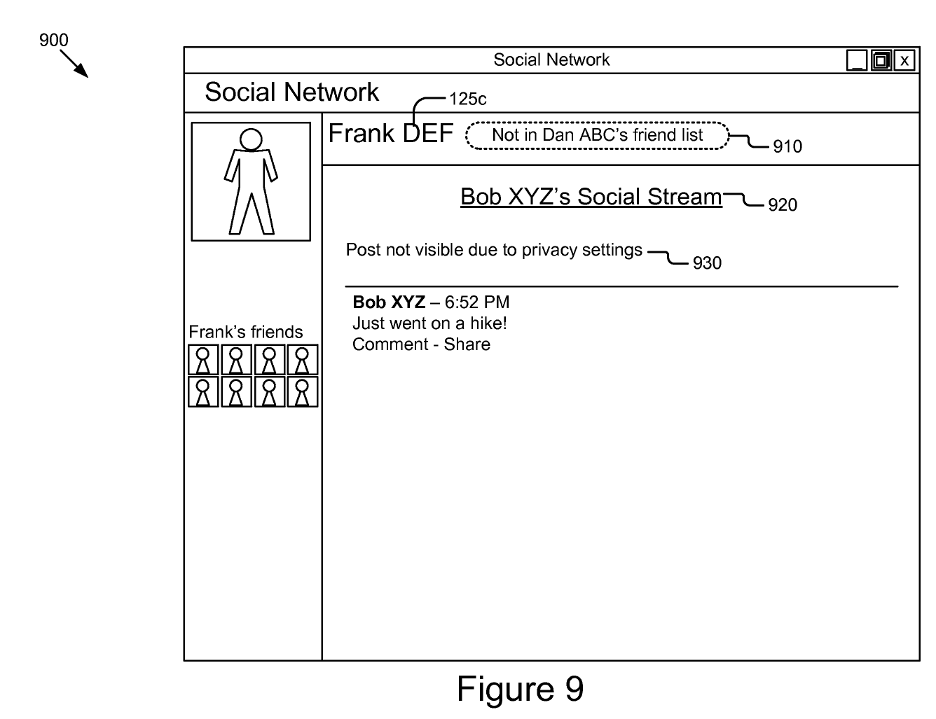

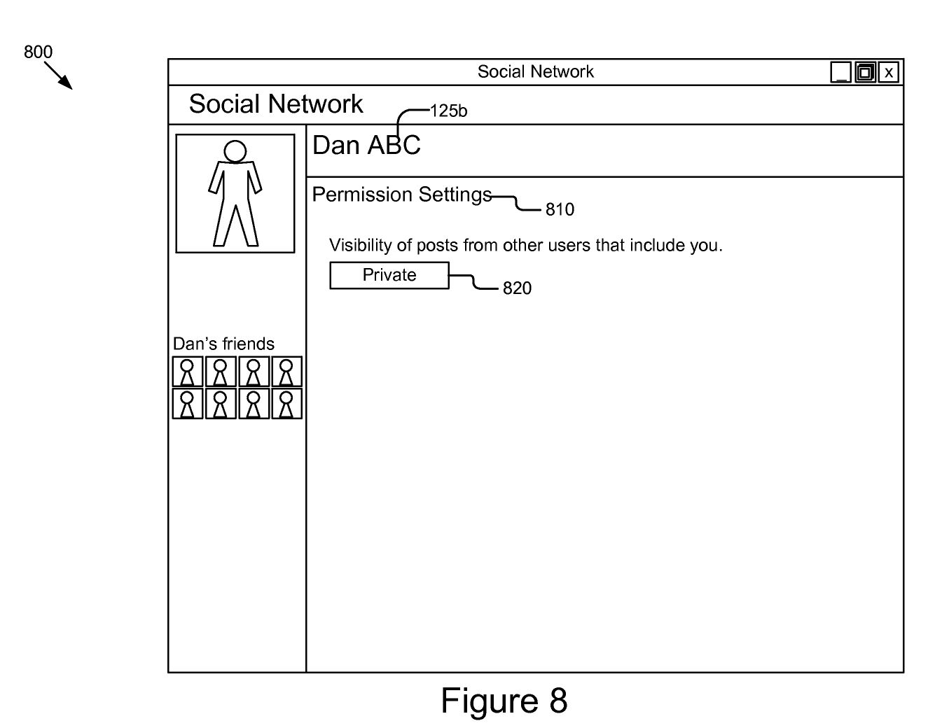

FIG. 8 is a graphical representation of an example user interface (indicated by reference numeral 800) illustrating a scenario where a user sets his own permission settings. In this instance, the action is setting permission settings 810 within the social network, for example, setting the visibility of posts from other users that include Dan ABC (user 125b) to private (as indicated by reference numeral 820). In this example of the user interface 700, a browser window is illustrated including a social network application. In this example, the user 125b has set his permission to private, therefore, the system receives the privacy settings for Dan ABC (user 125b) as private.

FIG. 9 is a graphical representation of an example user interface (indicated by reference numeral 900) illustrating a scenario where a user views the social stream of another user. In this instance, the action is Frank DEF (user 125c) viewing Bob XYZ's (user 125a) social stream 920, for example, Frank DEF (user 125c) views Bob XYZ's (user 125a) social stream 920 including one or more posts. In this example of the user interface 700, a browser window is illustrated including a social network application. In this example, Frank DEF is not in Dan ABC's friend list as indicated by reference numeral 910. Therefore, the photograph including Dan ABC (user 125b) (FIG. 7) is not visible to Frank DEF (user 125c) because Frank DEF (user 125c) is not in Dan ABC's friend list. Likewise, the user interface 900 may include other routine indications, for example, a post indicating that Bob XYZ (user 125a) went on a hike, with indications to either comment or share the post.

In the preceding description, for purposes of explanation, numerous specific details are indicated in order to provide a thorough understanding of the technology described. This technology may be practiced without these specific details. In the instances illustrated, structures and devices are shown in block diagram form in order to avoid obscuring the technology. For example, the present technology is described with some implementations illustrated above with reference to user interfaces and particular hardware. However, the present technology applies to a computing device that can receive data and commands, and devices providing services. Moreover, the present technology is described above primarily in the context of determining and controlling social content visibility within a social network; however, the present technology may apply to a situation and may be used for other applications beyond networks, in particular, social networks. In particular, this technology may be used in other contexts besides social networks.

Reference in the specification to “one implementation,” “an implementation,” or “some implementations” means simply that one or more particular features, structures, or characteristics described in connection with the one or more implementations is included in at least one or more implementations that are described. The appearances of the phrase “in one implementation or instance” in various places in the specification are not necessarily referring to the same implementation or instance.

Some portions of the detailed descriptions that precede are presented in terms of algorithms and symbolic representations of operations on data bits within a computer memory of either one or more computing devices. These algorithmic descriptions and representations are the means used to most effectively convey the substance of the technology. An algorithm as indicated here, and generally, may be conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that these and similar terms are to be associated with the appropriate physical quantities and are merely convenient labels applied to these quantities. Unless specifically stated otherwise, as apparent from the preceding discussion, it should be appreciated that throughout the description, discussions utilizing terms, for example, “processing,” “computing,” “calculating,” “determining,” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present technology also relates to an apparatus for performing the operations described here. This apparatus may be specially constructed for the required purposes, or it may include a general-purpose computer selectively activated or reconfigured by a computer program stored in the computer. For example, a computer program may be stored in a computer-readable storage medium, for example, but not limited to, a disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or a type of media suitable for storing electronic instructions, each coupled to a computer system bus.

This technology may take the form of an entirely hardware implementation, an entirely software implementation, or an implementation including both hardware and software components. In some instances, this technology may be implemented in software, which includes but may be not limited to firmware, resident software, microcode, etc.

Furthermore, this technology may take the form of a computer program product accessible from a computer-usable or computer-readable medium providing program code for use by or in connection with a computer or an instruction execution system. For the purposes of this description, a computer-usable or computer-readable medium may be an apparatus that can include, store, communicate, propagate, or transport the program for use by or in connection with the instruction execution system, apparatus, or device.

A data processing system suitable for storing and/or executing program code includes at least one processor coupled directly or indirectly to memory elements through a system bus. The memory elements may include local memory employed during actual execution of the program code, bulk storage, and cache memories, which provide temporary storage of at least some program code in order to reduce the number of times code may be retrieved from bulk storage during execution.

Input/output or I/O devices (including but not limited to keyboards, displays, pointing devices, etc.) may be coupled to the system either directly or through intervening I/O controllers.

Communication units including network adapters may also be coupled to the systems to enable them to couple to other data processing systems, remote printers, or storage devices, through either intervening private or public networks. Modems, cable modems, and Ethernet cards are just a few examples of the currently available types of network adapters.

Finally, the algorithms and displays presented in this application are not inherently related to a particular computer or other apparatus. Various general-purpose systems may be used with programs in accordance with the teachings here, or it may prove convenient to construct more specialized apparatus to perform the required method steps. The required structure for a variety of these systems is outlined in the description above. In addition, the present technology is not described with reference to a particular programming language. It should be understood that a variety of programming languages may be used to implement the technology as described here.

The foregoing description of the implementations of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. The present technology may be implemented in other specific forms, without departing from the spirit or essential characteristics thereof. Likewise, the particular naming and division of the modules, routines, features, attributes, methodologies, and other aspects are not mandatory or significant, and the mechanisms that implement the present disclosure or its features may have different names, divisions and/or formats. Furthermore, the modules, routines, features, attributes, methodologies and other aspects of the present technology can be implemented as software, hardware, firmware, or a combination of the three. Also, wherever a component, an example of which may be a module, of the present technology may be implemented as software, the component can be implemented as a standalone program, as part of a larger program, as a plurality of separate programs, as a statically or dynamically linked library, as a kernel loadable module, as a device driver, and/or in other ways. Additionally, the present technology is in no way limited to implementation in a specific programming language, or for a specific operating system or environment. Accordingly, the disclosure of the present technology is intended to be illustrative, but not limiting, of the scope of the present disclosure, which is set forth in the following claims.

1. A method, comprising:
receiving, using a computing device, social content from a first user within a network;
determining, using the computing device, a second user identified in the social content;
evaluating, using the computing device, an indication by the first user to provide the social content to a third user in the network, wherein the first, second and third users are different users;
receiving, using the computing device, a user restriction by the second user identified in the social content, the user restriction controlling visibility of the social content to the third user despite the indication by the first user to provide the social content to the third user, the third user within the network and outside a designated subset within the network, the designated subset within the network designated by the second user to indicate user preferences of the second user regarding when the second user appears in the social content received from the first user;
considering, using the computing device, the user preferences of the second user in relation to the social content before providing the social content to the third user;
determining, using the computing device, visibility of the social content to the third user based on the user restriction by the second user identified in the social content despite the indication by the first user to provide the social content to the third user; and
controlling, using the computing device, visibility of the social content based on the user restrictions designated by the second user for the social content received from the first user despite the indication by the first user to provide the social content to the third user.

2. (canceled)

3. The method according to claim 1, wherein the social content is a post within the network.

4. The method according to claim 3, wherein the social content is a comment to the post of the user within the network.

5. The method according to claim 1, wherein the social content is a friend list of the user within the network.

6. The method according to claim 1, wherein the social content is an invitation list of the user within the network.

7. A computer program product comprising a non-transitory computer readable medium including a computer readable program, wherein the computer readable program when executed on a computer causes the computer to:
receive social content from a first user within a network;
determine a second user identified in the social content;
evaluate an indication by the first user to provide the social content to a third user in the network, wherein the first, second and third users are different users;
receive a user restriction by the second user identified in the social content, the user restriction controlling visibility of the social content to the third user despite the indication by the first user to provide the social content to the third user, the third user within the network and outside a designated subset within the network, the designated subset within the network designated by the second user to indicate user preferences of the second user regarding when the second user appears in the social content received from the first user;
consider the user preferences of the second user in relation to the social content before providing the social content to the third user;
determine visibility of the social content to the third user based on the user restriction by the second user identified in the social content despite the indication by the first user to provide the social content to the third user; and
control visibility of the social content based on the user restrictions designated by the second user for the social content received from the first user despite the indication by the first user to provide the social content to the third user.

8. (canceled)

9. The computer program product according to claim 7, wherein the social content is a post within the network.

10. The computer program product according to claim 9, wherein the social content is a comment to the post of the user within the network.

11. The computer program product according to claim 7, wherein the social content is a friend list of the user within the network.

12. The computer program product according to claim 7, wherein the social content is an invitation list of the user within the network.

13. A system, comprising:
a processor, and;
a memory storing instructions that, when executed, cause the system to:
receive social content from a first user within a network;
determine a second user identified in the social content;
evaluate an indication by the first user to provide the social content to a third user in the network, wherein the first, second and third users are different users;
receive a user restriction by the second user identified in the social content, the user restriction controlling visibility of the social content to the third user despite the indication by the first user to provide the social content to the third user, the third user within the network and outside a designated subset within the network, the designated subset within the network designated by the second user to indicate user preferences of the second user regarding when the second user appears in the social content received from the first user;
consider the user preferences of the second user in relation to the social content before providing the social content to the third user;
determine visibility of the social content to the third user based on the user restriction by the second user identified in the social content despite the indication by the first user to provide the social content to the third user; and
control visibility of the social content based on the user restrictions designated by the second user for the social content received from the first user despite the indication by the first user to provide the social content to the third user.

14. (canceled)

15. The system according to claim 13, wherein the social content is a post within the network.

16. The system according to claim 13, wherein the social content is a comment on a post of the first user within the network.

17. The system according to claim 13, wherein the social content is a friend list of the first user within the network.

18. The system according to claim 13, wherein the social content is an invitation list of the first user within the network.

19. The method according to claim 1, wherein specifying the restriction on visibility of the social content is a private setting and only other users within the network on a friends list of the second user have a permission to view the social content provided by the first user.

20. The system according to claim 13, wherein specifying the restriction on visibility of the social content is a private setting and only other users within the network on a friends list of the second user have a permission to view the social content provided by the first user.

21. The method according to claim 1, wherein executing the visibility of the social content based on the user restrictions designated by second user for the social content removes visible identification of the second user to the third user when the social content is viewed by the third user.

22. The method according to claim 21, wherein the visible identification of the second user is one or more of a name of the second user, an identifier of the second user as a recipient of the social content, a tag identifying the second user within the social content and a response of the second user to the social content.

23. The system according to claim 13, wherein executing the visibility of the social content based on the user restrictions designated by the second user for the social content removes visible identification of the second user to the third user when the social content is viewed by the third user.
